(19) United States
(12) Patent Application Publication
(10) Pub. No.: US 2022/0181614 A1
(43) Pub. Date: Jun. 9, 2022

(54) SILICON-BASED COMPOSITE MATERIAL WITH POMEGRANATE-LIKE STRUCTURE, METHOD FOR PREPARING SAME, AND USE THEREOF

(71) Applicant: Guangdong Kaijin New Energy Technology Co., Ltd., Dongguan (CN)

(72) Inventors: Anhua ZHENG, Dongguan (CN); Dexin YU, Dongguan (CN); Yongjun YANG, Dongguan (CN); Yunlin YANG, Dongguan (CN)

(73) Assignee: Guangdong Kaijin New Energy Technology Co., Ltd., Dongguan (CN)

(21) Appl. No.: 17/493,968

(22) Filed: Oct. 5, 2021

(30) Foreign Application Priority Data
Dec. 7, 2020 (CN) 202011417880.4
Jun. 9, 2021 (CN) 202110641310.1

(51) Int. Cl. H01M 4/38; H01M 10/0525; H01M 4/36; H01M 4/62

(52) U.S. Cl. CPC H01M 4/386; H01M 10/0525; H01M 2004/027; H01M 4/625; H01M 4/628; H01M 4/362

(57) ABSTRACT

The present invention relates to the field of anode materials for batteries, and in particular, relates to a silicon-based composite material with a pomegranate-like structure. The silicon-based composite material with the pomegranate-like structure is composed of nano-silicon particles, exfoliated graphite, and a filler modification layer. The nano-silicon particles are dispersed in pores inside the exfoliated graphite. The filler modification layer is filled in the nano-silicon particles or filled between the nano-silicon particles and the exfoliated graphite. The present invention provides the silicon-based composite material with the pomegranate-like structure and a method for preparing the same, whereby a volumetric expansion effect can be reduced, and a cycle performance and a rate performance can be improved. The present invention further provides a use of the silicon-based composite material with the pomegranate-like structure, which is stable in product performance and shows good application prospects.

### FIELD

The present invention relates to the field of anode materials for lithium batteries, and in particular relates to a silicon-based composite material with a pomegranate-like structure, a method for preparing the same, and a use thereof.

### BACKGROUND

At present, commercial anode materials are mainly graphite materials such as natural graphite, artificial graphite, and intermediate phases thereof, which, however due to their low theoretic capacity (372 mAh/g), cannot meet the market needs. In recent years, the attention of people has focused on novel anode materials with high specific capacity, such as lithium storage metals (such as Sn and Si) and oxides thereof, as well as lithium transition metal phosphides. Among numerous novel anode materials with a high specific capacity, Si has become one of the most potential alternatives to graphite materials due to its high theoretical specific capacity (4200 mAh/g). However, Si-based materials show a great volumetric effect during a charge/discharge process, and are likely to undergo cracking and dusting to lose contact with a current collector, leading to a sharp decrease of a cycle performance. In addition, the silicon-based materials have low intrinsic conductivity and poor rate performance. Therefore, how to reduce the volumetric expansion effect and improve the cycle performance and rate performance has great significance in the application of the silicon-based materials in lithium-ion batteries.

Current silicon/carbon anode materials are composite materials prepared by granulating nano-silicon, graphite, and carbon. Since the nano-silicon is coated on the surfaces of the graphite particles to form core-shell structures, micro-size graphite particles cannot release stresses well in a discharge process, which causes damages to local structures and affects the overall performance of the materials. Therefore, how to reduce the volumetric expansion effect and improve the cycle performance has great significance in the application of silicon-based materials in lithium-ion batteries.

### SUMMARY

To solve the technical problems described above, the present invention provides a silicon-based composite material with a pomegranate-like structure and a method for preparing the same, whereby a volumetric expansion effect can be reduced, and a cycle performance and a rate performance can be improved.

The present invention further provides a use of the silicon-based composite material with the pomegranate-like structure, which is stable in product performance and shows good application prospects.

The present invention employs the following technical solution:

A silicon-based composite material with a pomegranate-like structure is composed of nano-silicon particles, exfoliated graphite, and a filler modification layer; the nano-silicon particles are dispersed in pores inside the exfoliated graphite; and the filler modification layer is filled in the nano-silicon particles or between the nano-silicon particles and the exfoliated graphite.

As a further improvement of the technical solution described above, the silicon-based composite material with the pomegranate-like structure has a particle size D50 of 2-40 μm; the silicon-based composite material with the pomegranate-like structure has a specific surface area of 0.5-15 m²/g; the silicon-based composite material with the pomegranate-like structure has an oxygen content of 0-20%; the silicon-based composite material with the pomegranate-like structure has a carbon content of 20-90%; and the silicon-based composite material with the pomegranate-like structure has a silicon content of 5-90%.

As a further improvement of the technical solution described above, the exfoliated graphite is powder or emulsion.

As a further improvement of the technical solution described above, the filler modification layer is a carbon modification layer, which is at least one in number, with a monolayer thickness of 0.2-1.0 sm.

As a further improvement of the technical solution described above, the nano-silicon is SiOₓ, with X being 0-0.8; the nano-silicon has an oxygen content of 0-31%; the nano-silicon particle has a grain size of 1-40 nm, and is one or both of polycrystalline nano-silicon or amorphous nano-silicon; and the nano-silicon has a particle size D50 of 30-150 nm.

A method for preparing a silicon-based composite material with a pomegranate-like structure includes the following steps:

S0: evenly mixing and dispersing nano-silicon particles, a carbon source, and a dispersant in an organic solvent to prepare a slurry A;

S1: adding exfoliated/emulsified graphite into the slurry A under a state of negative pressure, and filling the evenly mixed slurry A to gaps among the exfoliated/emulsified graphite by virtue of the negative pressure to prepare a slurry B;

S2: spraying and drying the slurry B to prepare a precursor C;

S3: mechanically mixing and mechanically fusing the precursor C and the carbon source to prepare a precursor D; and

S4: thermally treating and sieving the precursor D to prepare the silicon-based composite material with the pomegranate-like structure.

As a further improvement of the technical solution described above, in Step S1, the negative pressure refers to one or more of a vacuum stirring process, an emulsifying process, and a stirring and dispersing process using a disperser.

As a further improvement of the technical solution described above, in Step S4, the thermal treatment includes one of static thermal treatment or dynamic thermal treatment.

As a further improvement of the technical solution described above, the static thermal treatment includes: placing the precursor D in a chamber furnace or a roller kiln, raising the temperature to 400-1000° C. at a rate of 1-5° C./min under a protective atmosphere, preserving the heat for 0.5-20 h, and naturally cooling to room temperature; and the dynamic thermal treatment includes: placing the precursor D in the roller kiln, raising the temperature to 400-1000° C. at a rate of 1-5° C./min under a protective atmosphere, introducing a gas of an organic carbon source at an introduction rate of 0-20.0 L/min, preserving the heat for 0.5-20 h, and naturally cooling to room temperature.

A use of a silicon-based composite material with a pomegranate-like structure is provided, wherein the silicon-based composite material with the pomegranate-like structure is applicable to an anode material of a lithium-ion battery.

The present invention has the following beneficial effects:

The exfoliated graphite inside the silicon-based composite material with the pomegranate-like structure according to the present invention can play a good role in a conductive network, which can effectively improve the conductivity of the silicon-based material; and meanwhile, the flexible porous structure of the exfoliated graphite can effectively alleviate the volumetric effect during the charge/discharge process, which effectively avoids the dusting of the material during a cycle process, alleviates the volumetric expansion effect of the silicon-based material, and improves the cycle performance, thereby improving the conductivity and the rate performance. The filler modification layer can reduce side reactions by preventing direct contact between the nano-silicon and the electrolytes, and meanwhile, can further effectively improve the conductivity of the silicon-based material and alleviate the volumetric effect energy during the charge/discharge process.

### BRIEF DESCRIPTION OF THE DRAWINGS

FIG. 1 is a scanning electron microscope graph of a material prepared in Embodiment 4 of a silicon-based composite material with a pomegranate-like structure according to the present invention; and

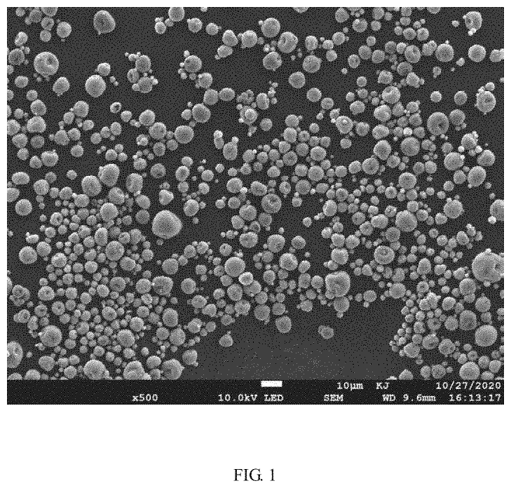

FIG. 2 is a diagram of initial charge/discharge curves of the material prepared in Embodiment 4 of the silicon-based composite material with the pomegranate-like structure according to the present invention.

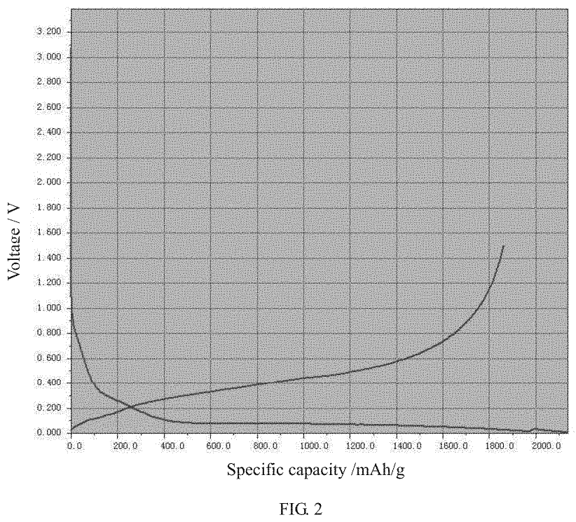

### DESCRIPTION OF THE EMBODIMENTS

The technical solutions in the embodiments of the present invention will be described clearly and completely below in conjunction with the embodiments of the present invention.

A silicon-based composite material with a pomegranate-like structure is composed of nano-silicon particles, exfoliated graphite, and a filler modification layer. The nano-silicon particles are dispersed in pores inside the exfoliated graphite, and the filler modification layer is filled in nano-silicon particles or between the nano-silicon particles and the exfoliated graphite.

The silicon-based composite material with the pomegranate-like structure has a particle size D50 of 2-40 μm, further preferably 2-20 μm, and particularly preferably 2-10 min. The silicon-based composite material with the pomegranate-like structure has a specific surface area of 0.5-15 m²/g, further preferably 0.5-10 m²/g, and particularly preferably 0.5-5 m²/g. The silicon-based composite material with the pomegranate-like structure has an oxygen content of 0-20%, further preferably 0-10%, and particularly preferably 0-5%. The silicon-based composite material with the pomegranate-like structure has a carbon content of 20-90%, further preferably 20-60%, and particularly preferably 20-50%, and the silicon-based composite material with the pomegranate-like structure has a silicon content of 5-90%, further preferably 20-70%, and particularly preferably 30-60%.

The exfoliated graphite is powder or emulsion.

The filler modification layer is a carbon modification layer, which is at least one in number, with a monolayer thickness of 0.2-1.0 μm.

The nano-silicon is SiOₓ, with X being 0-0.8. The nano-silicon has an oxygen content of 0-31%, preferably 0-20%, and further preferably 0-15%. The nano-silicon particle has a grain size of 1-40 nm, and is one or both of polycrystalline nano-silicon or amorphous nano-silicon; and the nano-silicon particle has a particle size D50 of 30-150 nm, further preferably 30-110 nm, and particularly preferably 50-100 nm.

A method for preparing a silicon-based composite material with a pomegranate-like structure includes the following steps:

S0: evenly mixing and dispersing nano-silicon particles, a carbon source, and a dispersant in an organic solvent to prepare a slurry A;

S1. adding exfoliated/emulsified graphite into the slurry A under a state of negative pressure, and filling the evenly mixed slurry A to gaps/pores among the exfoliated/emulsified graphite by virtue of the negative pressure to prepare a slurry B;

S2: spraying and drying the slurry B to prepare a precursor C;

S3: mechanically mixing and mechanically fusing the precursor C and the carbon source to prepare a precursor D; and

S4: thermally treating and sieving the precursor D to prepare the silicon-based composite material with the pomegranate-like structure.

According to the method for preparing the silicon-based composite material with the pomegranate-like structure according to the present invention, the pores inside the exfoliated graphite are filled with the nano-silicon particles and the carbon source by means of the negative pressure; subsequently, the pores inside the exfoliated graphite are fully filled with the nano-silicon particles and the carbon source to thereby strengthen the exfoliated graphite by the spraying and drying as well as mechanical pressurization; and finally, the carbon source is pyrolyzed by the thermal treatment to form the filler modification layer.

In Step S1, the negative pressure refers to one or more of a vacuum stirring process, an emulsifying process, and an online dispersing process.

In Step S4, the thermal treatment includes one of static thermal treatment or dynamic thermal treatment.

The static thermal treatment includes: placing the precursor D in a chamber furnace or a roller kiln, raising the temperature to 400-1000° C. at a rate of 1-5° C./mm under a protective atmosphere, preserving the heat for 0.5-20 h, and naturally cooling to room temperature; and the dynamic thermal treatment includes: placing the precursor D in a rotary furnace, raising the temperature to 400-1000° C. at a rate of 1-5′C/min under a protective atmosphere, introducing a gas of organic carbon source at an introduction rate of 0-20.0 L/min, preserving the heat for 0.5-20 h, and naturally cooling to room temperature.

A use of a silicon-based composite material with a pomegranate-like structure is provided, where the silicon-based composite material with the pomegranate-like structure is applicable to an anode material of a lithium-ion battery.

### Embodiment 1

1. 1000 g of nano-silicon particles with a particle size D50 of 100 nm and 100 g of citric acid were mixed and dispersed evenly in ethyl alcohol to prepare a slurry A 1.

2. 50 g of exfoliated graphite was added to the slurry A1, being stirred and dispersed while being vacuumized to prepare a slurry B1.

3. The slurry B1 was sprayed and dried to prepare a precursor C1.

4. The precursor C1 and asphalt were mixed and fused at a mass ratio of 10:3, and subsequently sintered under a condition of a nitrogen protective atmosphere, where a temperature rise rate was 1° C./min, the thermal treatment was performed at the temperature of 1000° C., and the heat was preserved for 5 h; and a resultant was cooled and sieved to prepare the silicon-based composite material with the pomegranate-like structure.

### Embodiment 2

1. 1000 g of nano-silicon with a particle size D50 of 100 nm and 100 g of citric acid were mixed and dispersed evenly in ethyl alcohol to prepare a slurry A2.

2. 50 g of exfoliated graphite was added to the slurry A2 by using an online dispersion system to prepare a slurry B2.

3. The slurry B2 was sprayed and dried to prepare a precursor C2.

4. The precursor C2 and asphalt were mixed and fused at a mass ratio of 10:3, and subsequently sintered under a condition of a nitrogen protective atmosphere, where a temperature rise rate was 1° C./min, the thermal treatment was performed at the temperature of 1000° C., and the heat was preserved for 5 h; and a resultant was cooled and sieved to prepare the silicon-based composite material with the pomegranate-like structure.

### Embodiment 3

1. 1000 g of nano-silicon with a particle size D50 of 100 nm and 100 g of citric acid were mixed and dispersed evenly in ethyl alcohol to prepare a slurry A3.

2. 100 g of exfoliated graphite was added to the slurry A3 by using an online dispersion system to prepare a slurry B3.

3. The slurry B3 was sprayed and dried to prepare a precursor C3.

4. The precursor C3 and asphalt were mixed and fused at a mass ratio of 10:3, and subsequently sintered under a condition of nitrogen protective atmosphere, where a temperature rise rate was 1° C./min, the thermal treatment was performed at the temperature of 1000° C., and the heat was preserved for 5 h; and a resultant was cooled and sieved to prepare the silicon-based composite material with the pomegranate-like structure.

### Embodiment 4

1. 1000 g of nano-silicon with a particle size D50 of 100 nm and 50 g of citric acid were mixed and dispersed evenly in ethyl alcohol to prepare a slurry A4.

2. 100 g of exfoliated graphite was added to the slurry A4 by using an online dispersion system to prepare a slurry B4.

3. The slurry B4 was sprayed and dried to prepare a precursor C4.

4. The precursor C4 and asphalt were mixed and fused at a mass ratio of 10:4, and subsequently sintered under a condition of nitrogen protective atmosphere, where a temperature rise rate was 1° C./min, the thermal treatment was performed at the temperature of 1000° C., and the heat was preserved for 5 h; and a resultant was cooled and sieved to prepare the silicon-based composite material with the pomegranate-like structure.

### Embodiment 5

1. 1000 g of nano-silicon with a particle size D50 of 100 nm and 50 g of citric acid were mixed and dispersed evenly in ethyl alcohol to prepare a slurry A5.

2. 100 g of exfoliated graphite was added to the slurry A5 by using an online dispersion system to prepare a slurry B5.

3. The slurry B5 was sprayed and dried to prepare a precursor C5.

4. The precursor C5 and asphalt were mixed and fused at a mass ratio of 10:3, and subsequently sintered under a condition of a nitrogen protective atmosphere, where a temperature rise rate was 1° C./min, thermal treatment was performed at the temperature of 900° C., and the heat was preserved for 5 h; and a precursor D5 was prepared.

5. 1000 g of the prepared precursor D5 was placed in a CVD furnace and heated to 1000° C. at a temperature rise rate of 5° C./min; high-purity nitrogen and a methane gas were respectively introduced at rates of 4.0 L/min and 0.5 L/min, and a duration for introducing the methane gas was 0.5 h; and a resultant was cooled and sieved to prepare the silicon-based composite material with the pomegranate-like structure.

### Embodiment 6

1. 1000 g of nano-silicon with a particle size D50 of 50 nm and 50 g of citric acid were mixed and dispersed evenly in ethyl alcohol to prepare a slurry A6.

2. 100 g of exfoliated graphite was added to the slurry A6 by using an online dispersion system to prepare a slurry B6.

3. The slurry B6 was sprayed and dried to prepare a precursor C6.

4. The precursor C6 and asphalt were fused at a mass ratio of 10:3, and subsequently sintered under a condition of a nitrogen protective atmosphere, where a temperature rise rate was 1° C./min, thermal treatment was performed at the temperature of 900° C., and the heat was preserved for 5 h; and a precursor D6 was prepared.

5. 1000 g of the prepared precursor D6 was placed in a CVD furnace and heated to 1000° C. at a temperature rise rate of 5° C./min; high-purity nitrogen and a methane gas were respectively introduced at rates of 4.0 L/min and 0.5 L/min, and a duration for introducing the methane gas was 0.5 h; and a resultant was cooled and sieved to prepare the silicon-based composite material with the pomegranate-like structure.

### Comparative Examples

1. 1000 g of nano-silicon with a particle size D50 of 100 nm and 100 g of citric acid were mixed and dispersed evenly in ethyl alcohol to prepare a slurry A0.

2. The precursor A0 and asphalt were mixed and fused at a mass ratio of 10:3, and subsequently sintered under a condition of a nitrogen protective atmosphere, where a temperature rise rate was 1° C./mm, the thermal treatment was performed at the temperature of 1000° C., and the heat was preserved for 5 h; and a resultant was cooled and sieved to prepare a silicon-based composite material.

The embodiments and comparative examples described above were tested and detected in performance.

Test conditions: each of the materials prepared in the comparative example and the embodiments was taken as an anode material and mixed with a binder of polyvinylidene fluoride (PVDF) and a conductive agent (Super-P) at a mass ratio of 80:10:10; a proper amount of N-methylpyrrolidone (NMP) was added as a solvent to prepare a slurry, which was coated on a copper foil; the coated copper foil was vacuum-dried and rolled to prepare an anode piece; a metal lithium piece was used as a counter electrode, electrolyte prepared by using 1 mol/L of LiPF6 three-component mixed solvent at a mixing ratio of EC:DMC:EMC=1:1:1 (v/v) was used, and a polypropylene microporous membrane was used as a partition diaphragm; and a CR2032 type button battery was assembled in a glove box filled with an inert gas. Charge/discharge tests of the button batteries were performed on a battery test system in Landian Electronics (Wuhan) Co., Ltd. The charge/discharge occurred with the constant current of 0.1 C at room temperature, and a charge/discharge voltage was limited to 0.005-1.5 V.

A method for testing and calculating a volumetric expansion rate of each of the materials was as follows: a composite material with a capacity of 500 mAh/g was prepared by compounding the prepared silicon/carbon composite material and graphite, and then tested the cycle performance, wherein an expansion rate=(pole piece thickness after 50 cycles−pole piece thickness before cycles)/(pole piece thickness before cycles−copper foil thickness)*100%.

As shown in Table 1 and Table 2, Table 1 shows the results of initial-cycle tests of the comparative example and the embodiments, and Table 2 shows the results of the cyclic expansion tests.

TABLE 1

| | Initial charge | Initial discharge | Initial coulombic |
|---|---|---|---|
| | specific capacity | specific capacity | efficiency |
| | (mAh/g) | (mAh/g) | (%) |
| Comparative | 2399.1 | 2053.6 | 85.6 |
| Example | | | |
| Embodiment 1 | 2289.4 | 1964.3 | 85.8 |
| Embodiment 2 | 2268.1 | 1957.4 | 86.3 |
| Embodiment 3 | 2263.5 | 1964.7 | 86.8 |
| Embodiment 4 | 2137.4 | 1861.9 | 87.1 |
| Embodiment 5 | 2082.8 | 1851.6 | 88.9 |
| Embodiment 6 | 2121.3 | 1879.5 | 88.6 |

TABLE 2

| | Initial discharge | 50-cycle | 50-cycle capacity |
|---|---|---|---|
| | specific capacity | expansion rate | retention rate |
| | (mAh/g) | (%) | (%) |
| Embodiment 1 | 501.3 | 62.5 | 72.2 |
| Embodiment 2 | 502.5 | 58.5 | 80.3 |
| Embodiment 3 | 502.3 | 56.2 | 85.4 |
| Embodiment 4 | 503.1 | 54.7 | 88.7 |
| Embodiment 5 | 500.6 | 52.4 | 89.9 |
| Embodiment 6 | 501.7 | 49.3 | 92.3 |

The exfoliated graphite inside the silicon-based composite material with the pomegranate-like structure according to the present invention can play a good role of a conductive network, which can effectively improve the conductivity of the silicon-based material; and meanwhile, the flexible porous structure of the exfoliated graphite can effectively alleviate the volumetric effect during the charge/discharge process, which effectively avoids the dusting of the material during a cycle process, alleviates the volumetric expansion effect of the silicon-based material, and improves the cycle performance, thereby improving the conductivity and the rate performance. The filler modification layer can reduce side reactions by preventing direct contact between the nano-silicon and the electrolytes, and meanwhile, can further effectively improve the conductivity of the silicon-based material and alleviate the volumetric effect energy during the charge/discharge process.

The embodiments above only provide specific and detailed descriptions of several implementations of the present invention, and therefore should not be construed to limit the patent scope of the present invention. It should be noted that several variations and improvements can be made by those of ordinary skills in the art without departing from the concept of the present invention, and shall be construed as falling within the protection scope of the present invention. Therefore, the patent protection scope of the present invention shall be subject to the accompanying claims.

What is claimed is:

1. A silicon-based composite material with a pomegranate-like structure, wherein the silicon-based composite material with the pomegranate-like structure is composed of nano-silicon particles, exfoliated graphite, and a filler modification layer; the nano-silicon particles are dispersed in pores inside the exfoliated graphite; and the filler modification layer is filled in the nano-silicon particles or between the nano-silicon particles and the exfoliated graphite.

2. The silicon-based composite material with the pomegranate-like structure according to claim 1, wherein the silicon-based composite material with the pomegranate-like structure has a particle size D50 of 2-40 μm; and the silicon-based composite material with the pomegranate-like structure has a specific surface area of 0.5-15 m²/g.

3. The silicon-based composite material with the pomegranate-like structure according to claim 1, wherein the silicon-based composite material with the pomegranate-like structure has an oxygen content of 0-20%, a carbon content of 20-90% and a silicon content of 5-90%.

4. The silicon-based composite material with the pomegranate-like structure according to claim 1, wherein the exfoliated graphite is powder or emulsion.

5. The silicon-based composite material with the pomegranate-like structure according to claim 1, wherein the filler modification layer is a carbon modification layer, which is at least one in number, with a monolayer thickness of 0.2-1.0 μm.

6. The silicon-based composite material with the pomegranate-like structure according to claim 1, wherein the nano-silicon is SiOₓ, with X being 0-0.8; the nano-silicon particle has an oxygen content of 0-31%; and the nano-silicon has a particle size D50 of 30-150 nm.

7. The silicon-based composite material with the pomegranate-like structure according to claim 1, wherein the nano-silicon particle is one or both of polycrystalline nano-silicon or amorphous nano-silicon and has a grain size of 1-40 nm.

8. A method for preparing a silicon-based composite material with a pomegranate-like structure, comprising:
S0: evenly mixing and dispersing nano-silicon particles, a carbon source, and a dispersant in an organic solvent to prepare a slurry A;
S1: adding exfoliated/emulsified graphite into the slurry A under a state of negative pressure, and filling the evenly mixed slurry A to gaps among the exfoliated/emulsified graphite by virtue of the negative pressure to prepare a slurry B;
S2: spraying and drying the slurry B to prepare a precursor C;
S3: mechanically mixing and mechanically fusing the precursor C and the carbon source to prepare a precursor D; and
S4: thermally treating and sieving the precursor D to prepare the silicon-based composite material with the pomegranate-like structure.

9. The method for preparing the silicon-based composite material with the pomegranate-like structure according to claim 8, wherein in S1, the negative pressure is created by one or more of a vacuum stirring process, an emulsifying process, and a stirring and dispersing process using a disperser.

10. The method for preparing the silicon-based composite material with the pomegranate-like structure according to claim 8, wherein in S4, the thermal treatment comprises one of static thermal treatment and dynamic thermal treatment; and in S4, the carbon source is pyrolyzed to form a carbon filled modification layer.

11. The method for preparing the silicon-based composite material with the pomegranate-like structure according to claim 10, wherein the static thermal treatment comprises; placing the precursor D in a chamber furnace or a roller kiln, raising a temperature of the chamber furnace or the roller kiln to 400-1000° C. at a rate of 1-5° C./min under a protective atmosphere, preserving the heat for 0.5-20 h, and naturally cooling to room temperature;

12. The method for preparing the silicon-based composite material with the pomegranate-like structure according to claim 10, wherein the dynamic thermal treatment comprises: placing the precursor D in a rotary furnace, raising a temperature of the rotary furnace to 400-1000° C. at a rate of 1-5° C./min under a protective atmosphere, introducing a gas of organic carbon source at an introduction rate of 0-20.0 L/min, preserving the heat for 0.5-20 h, and naturally cooling to room temperature.

13. A use of the silicon-based composite material with a pomegranate-like structure according to claim 1, wherein the silicon-based composite material with the pomegranate-like structure is applicable to an anode material of a lithium-ion battery.
